(19) United States
(12) Patent Application Publication
(10) Pub. No.: US 2004/0231727 A1
(43) Pub. Date: Nov. 25, 2004

(54) Pressure reducing valve

(75) Inventors: Kaoru Nomichi, Hyogo (JP); Seiji Ishii, Hyogo (JP); Makoto Ninomiya, Hyogo (JP)

Correspondence Address: MARSHALL, GERSTEIN & BORUN LLP, 6300 SEARS TOWER, 233 S. WACKER DRIVE, CHICAGO, IL, 60606, US

(73) Assignee: KABUSHIKI KAISHA KAWASAKI PRECISION MACHINERY, Kobe (JP)

(21) Appl. No.: 10/849,078

(22) Filed: May 19, 2004

(30) Foreign Application Priority Data
Nov. 13, 2001 (JP) 2001-347569

(51) Int. Cl. G05D 16/10

(52) U.S. Cl. 137/505.25

(57) ABSTRACT

A pressure reducing valve 20 is constructed such that a piston 22 is provided within a housing 21 provided with a primary port 28 and a secondary port 30 to form a primary pressure chamber 64 of a primary pressure P1 and a secondary pressure chamber 70 of a secondary pressure P2 which are connected to each other through an orifice 63. The piston 22 is subjected to the primary pressure P1 applied in one direction X1 in the axial direction and the secondary pressure P2 applied in the opposite direction X2 in the axial direction. A spring 23 exerts a force to the piston 22 in the direction X1. A back pressure chamber 55 is kept at the primary pressure P1 to cause the primary pressure P1 to be applied to the piston 22 in the opposite direction X2.

### BACKGROUND OF THE INVENTION

1. Field of the Invention

The present invention relates to a pressure reducing valve mounted in a fluid pressure device or the like.

2. Description of the Related Art

FIG. 4 is a cross-sectional view schematically showing a conventional pressure reducing valve 1. The pressure reducing valve 1 is constructed such that a piston 3 is held to be movable within a housing 2 in an axial direction of the valve 1, and a spring 4 is mounted on the piston 3 to apply a force to the piston 3 in a direction x1 in the axial direction. In FIG. 4, the direction x1 is leftward and an opposite direction x2 is rightward. The housing 2 is provided with a primary port 5 and a secondary port 6. A protrusion 7 is formed to enclose the primary port 5. The protrusion 7 and a seat portion 8 of the piston 3 which is opposed to the protrusion 7 form an orifice 9 for reducing pressure. Thus, the housing 2 has an internal space separated by the orifice 9 into a primary pressure chamber 10 connected to the primer port 5 and a secondary pressure chamber 11 connected to the secondary port 6. The pressure reducing valve 1 is configured to reduce a primary pressure p1 of a fluid supplied to the primary port 5 to a secondary pressure p2 by flowing the fluid through the orifice 9 and to discharge the fluid through the secondary port 6.

FIGS. 5A and 5B are graphs showing the secondary pressure p2 of the pressure reducing valve 1. In the pressure reducing valve 1, the secondary pressure p2 is represented by the following formula (1) using the primary pressure p1:

$$p2 = \frac{k \cdot ( Δ h + z )}{a3 - a2} + \frac{a1}{a3 - a2} p1 \qquad ( 1 )$$

z=f(p1,q) (2)

where

a1 is a pressure receiving area of the piston 3 that receives the primary pressure p1 applied in the direction x1,

a2 is a pressure receiving area of the piston 3 that receives the secondary pressure p2 applied in the direction x1,

a3 is a pressure receiving area of the piston 3 that receives the secondary pressure p2 applied in the opposite direction x2,

k is a spring constant of the spring 4,

Δh is a flexure of the spring 4 in an initial state, and

z is a displacement of the piston 3 from an initial state.

As represented by the formula (2), z is represented by a function of the primary pressure p1 and a flow rate q of the fluid flowing downward within the pressure reducing valve 1.

In the pressure reducing valve 1, the piston 3 is adapted to receive the primary pressure p1 on a pressure receiving face having the area a1 only in the direction x1. Therefore, in the formula (1) representing the secondary pressure p2, first and second terms of a right side vary as the primary pressure p1 varies. Especially, the second term of the right side in the formula (1) greatly varies with the variation in the primary pressure pl. Therefore, as can be seen from FIG. 5A, the secondary pressure p2 greatly varies with the variation in the primary pressure p1.

In order to increase a flow capacity of the pressure reducing valve 1, i.e., a maximum allowable flow of the pressure reducing valve 1, it is necessary to increase a diameter of the protrusion 7. When the diameter of the protrusion 7 is increased, the pressure receiving area a1 increases, and the variation Δp2 in the secondary pressure p2 with respect to the variation Δp1 in the primary pressure p1 increases. In order to inhibit the increase in the variation Δp2, it is necessary to increase the pressure receiving area a3 for increasing a denominator of the second term of the right side in the formula (1). This increases a maximum outer diameter of the piston 3 and hence the outer diameter of the spring 4. As a result, a radial dimension of the pressure reducing valve 1 increases.

### SUMMARY OF THE INVENTION

The present invention has been developed under the circumstances, and an object of the present invention is to provide a pressure reducing valve capable of inhibiting an increase in a radial dimension and an increase in a variation in a secondary pressure with respect to a variation in a primary pressure.

According to the present invention, there is provided a pressure reducing valve comprising: a housing provided with a primary port and a secondary port; a piston held within the housing to be movable in an axial direction of the valve and configured to separate an internal space of the housing into a primary pressure chamber connected to the primary port and a secondary pressure chamber connected to the secondary port, the piston including a primary pressure receiving face having a primary pressure receiving area that receives a primary pressure applied in one direction in the axial direction from a fluid within a primary pressure chamber, a back pressure receiving face having a back pressure receiving area equal to the primary pressure receiving area, the back pressure receiving face being adapted to receive the primary pressure applied in an opposite direction in the axial direction from the fluid within a back pressure chamber fluidically connected to the primary pressure chamber and kept at the primary pressure, and a secondary pressure receiving face that receives a secondary pressure applied in the opposite direction from a fluid within the secondary pressure chamber; and a spring means configured to apply a force to the piston in the one direction.

In accordance with the invention, the piston is provided with the back pressure receiving face having the back pressure receiving area equal to the primary pressure receiving area to receive the primary pressure from the back pressure chamber. The primary pressure receiving face and the back pressure receiving face respectively receive the primary pressure from opposite directions in the axial direction. With regard to the primary pressure, a force applied to the piston in the one direction and a force applied to the piston in the opposite direction are balanced. In such a construction, the secondary pressure is less susceptible to the primary pressure. As a result, it is possible to significantly reduce a variation in the secondary pressure with respect to a variation in the primary pressure.

Even when the primary pressure receiving area of the piston that receives the primary pressure is increased for increasing a maximum allowable flow, the variation in the secondary pressure is not substantially affected by the variation in the primary pressure receiving area. So, it is not necessary to increase the maximum outer diameter of the piston in order to inhibit the increase in the variation in the secondary pressure with respect to the variation in the primary pressure. Therefore, it is possible to achieve a pressure reducing valve capable of increasing the maximum allowable flow while inhibiting an increase in the radial dimension thereof, and of inhibiting the increase in the variation in the secondary pressure.

Preferably, the pressure reducing valve may further comprise a rod provided within the housing, the rod being inserted into the piston to be movable relative to the piston in the axial direction to allow the back pressure chamber to be formed between the rod and the piston.

In accordance with the present invention, by inserting the rod provided within the housing into the piston, the back pressure chamber is formed between the piston and the rod. In this manner, by merely inserting the rod into the piston, it is possible to achieve the pressure reducing valve capable of inhibiting the variation in the secondary pressure with respect to the variation in the primary pressure.

The above and further objects and features of the invention will more fully be apparent from the following detailed description with accompanying drawings.

### BRIEF DESCRIPTION OF THE DRAWINGS

FIG. 1 is a cross-sectional view showing a pressure reducing valve according to an embodiment of the present invention;

FIG. 2 is a cross-sectional view showing a simplified structure of the pressure reducing valve of FIG. 1;

FIGS. 3A and 3B are graphs showing a secondary pressure of the pressure reducing valve;

FIG. 4 is a cross-sectional view schematically showing a simplified structure of the conventional pressure reducing valve; and

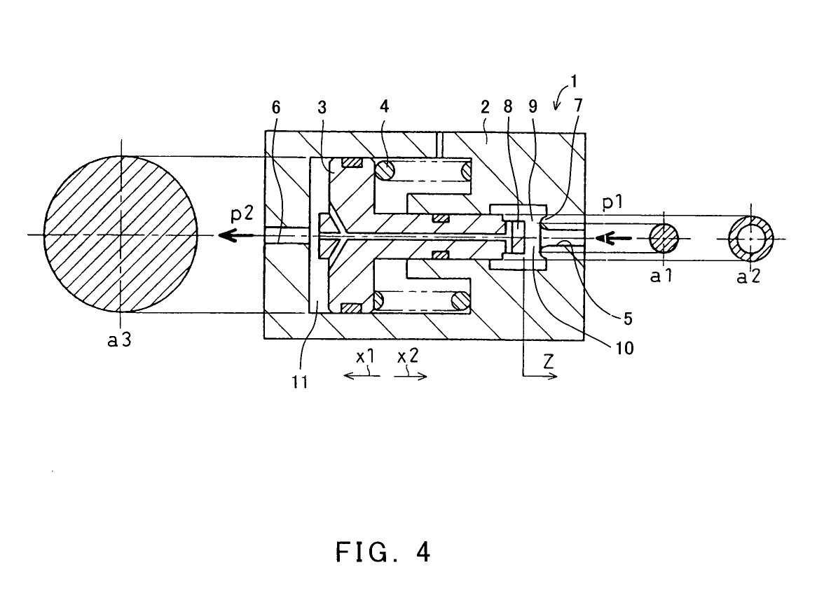

FIGS. 5A and 5B are graphs showing the secondary pressure of the pressure reducing valve.

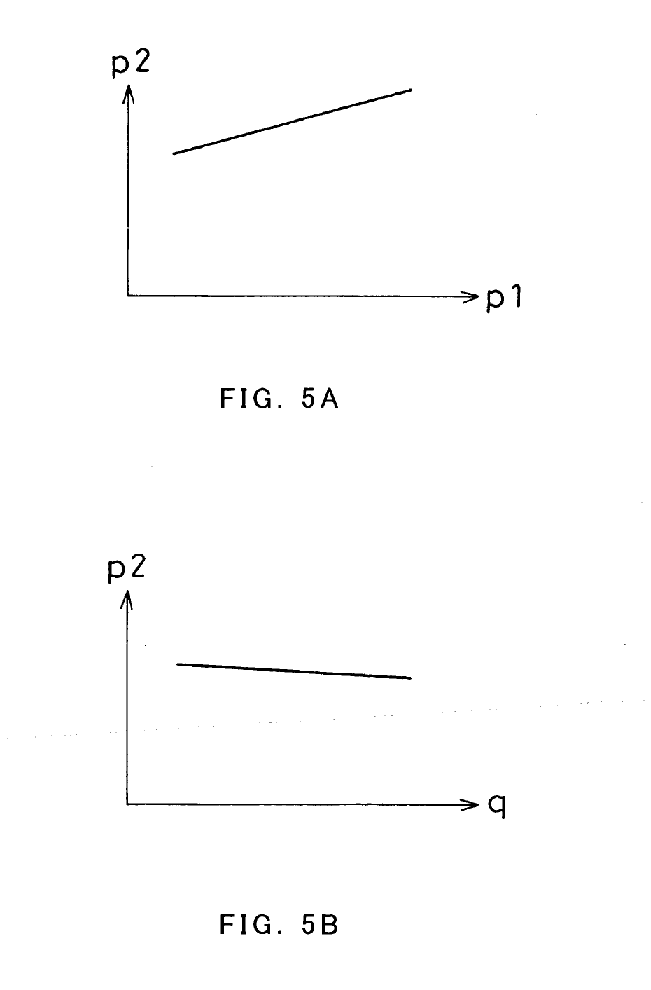

### DETAILED DESCRIPTION OF THE EMBODIMENTS

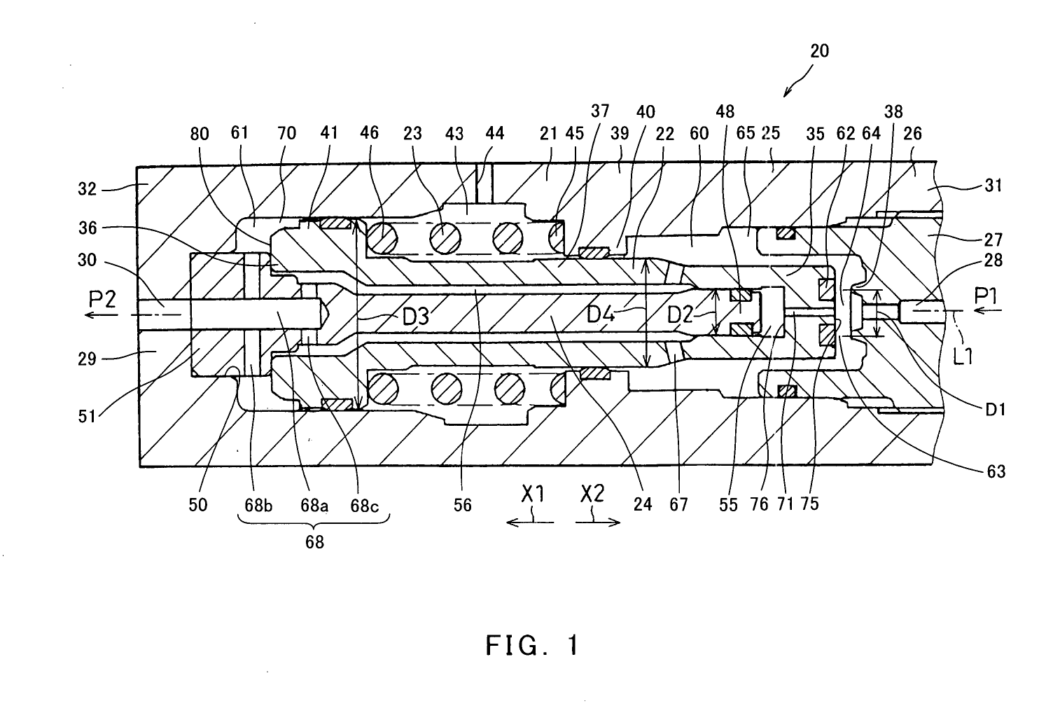

FIG. 1 is a cross-sectional view showing a pressure reducing valve 20 according to an embodiment of the present invention. The pressure reducing valve 20 is located in a flow passage through which a fluid flows from a primary side to a secondary side. The pressure reducing valve 20 is configured to reduce a primary pressure P1 of the fluid to a secondary pressure P2 lower than the primary pressure P1, and to discharge the fluid. The pressure reducing valve 20 includes a housing 21, a piston 22, a spring 23, and a rod 24. The housing 21, the piston 22, the spring 23, and the rod 24 are coaxially arranged and their axes correspond with an axis L1 of the pressure reducing valve 20.

The housing 21 includes a cylindrical housing body 25 having a bottom and provided with an opening end portion 26, and a cap member 27 inserted into the opening end portion 26 and attached. The cap member 27 is screwed to the housing body 25 rotatably around the axis L1 to be advanceable and retractable along the axis L1. Thus, the axial position of the cap member 27 is adjustable. An inner peripheral portion of the housing body 25 and an outer peripheral portion of the cap member 27 are sealed over the entire circumference.

A primary port 28 is formed within the cap member 27 to extend along the axis L1. A secondary port 30 is formed within a bottom portion 29 of the housing body 25 to extend along the axis L1. Thus, the housing 21 is provided with the primary port 28 at one end portion 31 in the axial direction and the secondary port 30 at the other (opposite) end portion 32 in the axial direction.

The cap member 27 is provided with an annular protrusion 38 configured to protrude inward within the housing 21 to be tapered in a direction x in the axial direction and to extend over the circumference so as to enclose the primary port 28. As used herein, the direction X1 is to be understood as a direction from the one end portion 31 toward the opposite end portion 32 in the axial direction, i.e., leftward in FIG. 1, and an opposite direction X2 is to be understood as the opposite direction of the direction X1, i.e., rightward in FIG. 1.

The piston 22 is cylindrical with a bottom. The piston 22 is held within the housing 21 such that a bottom portion 35 corresponding to one end portion in the axial direction is placed on the one end portion 31 side of the housing 21 and an opening end portion 36 corresponding to the opposite end portion in the axial direction is placed on the opposite end portion 32 side. Under this condition, the piston 22 is movable within the housing body 25 in the direction X1 and the opposite direction X2 along the axis L1.

A flanged convex portion 40 is formed in an intermediate portion 39 of the housing 21 between the both end portions 31 and 32 of the housing 21 and configured to protrude radially inward and to extend over the entire circumference. An outer peripheral portion of an intermediate portion 37 of the piston 22 between the bottom portion 35 and the opening end portion 36 is in contact with the inner peripheral portion of the convex portion 40 in a sealed state. A flanged convex portion 41 is formed in the opening end portion 36 of the piston 22 and configured to protrude radially outward and to extend over the entire circumference. An outer peripheral portion of the convex portion 41 is in contact with an inner peripheral portion of a portion of the intermediate portion 39 which is located closer to the opposite end portion 32 than the convex portion 40 in a sealed state.

The spring 23 as a spring means is a compression spring. The spring 23 is provided within the housing 21 in such a manner that the spring 23 is accommodated in an annular space 43 formed by the housing 21 and the piston 22 which are spaced apart from each other and externally mounted on the piston 22. The space 43 is formed between the convex portion 40 and the convex portion 41 and communicates with atmosphere through a communicating hole 44 formed in the housing 21.

The spring 23 is supported at one end portion 45 in the axial direction by the convex portion 40 and supported at an opposite end portion 46 in the axial direction by the convex portion 41. The spring 23 applies a force to the piston 22 in the direction X1 within the housing 21.

The rod 24 is substantially circular-cylindrical and is held within the housing 21. The rod 24 is structured such that one end portion 48 in the axial direction is inserted into the piston 22 so as to be movable in both the direction X1 and the direction X2 along the axis L1 and at least an opposite end portion 51 in the axial direction protrudes from the piston 22 in the direction X1. The opposite end portion 51 is larger in outer diameter than the remaining portion and supports the opening end portion 36 of the piston 22 in the axial direction.

A concave portion 50 is formed in the one end portion 32 of the housing 21, and hence a bottom portion 29 of the housing body 25. The rod 24 is held such that the opposite end portion 51 is fitted to the concave portion 50.

An outer peripheral portion of the one end portion 48 of the rod 24 is in contact with an inner peripheral portion of the piston 22 in a sealed state, and a back pressure chamber 55 is formed between the piston 22 and the rod 24. The rod 24 is configured such that an outer peripheral portion of a portion to be inserted into the piston 22, other than the one end portion 48, is radially spaced apart from an inner peripheral portion of the piston 22, thereby forming an annular piston inner space 56.

In the above-constructed pressure reducing valve 20, the outer peripheral portion of the piston 22 is in contact with the inner peripheral portion of the housing 21 at two positions in a sealed state over the circumference. Within the housing 21, a tubular space 60 with a bottom is formed rightward relative to the convex portion 40 and an annular space 61 is formed leftward relative to the convex portion 41, between the housing 21 and the piston 22.

The piston 22 is provided at an outer end face of the one end portion 35 with a seat portion 62 made of a predetermined resin and extending over the entire circumference. The seat portion 62 is axially opposed to the protrusion 38 of the cap member 27, thereby forming the annular orifice 63 between the seat portion 62 and the protrusion 38 to extend over the entire circumference. The space 60 has two regions 64 and 65 fluidically connected to each other through the orifice 63. The region 64 located radially inward relative to the orifice 63 is a primary pressure chamber 64 connected to the primary port 28.

A communicating hole 67 is formed at a position between the intermediate portion 37 of the piston 22 and a portion of the piston 22 with which the one end portion 48 of the rod 24 is in contact, to allow the inside and outside of the piston 22 to fluidically communicate with each other. The communicating hole 67 allows the region 65 of the space 60 which is located radially outward relative to the orifice 63 to communicate with the piston inner space 56.

A hole 68a that opens in the direction X1 and a hole 68b that opens radially outward are formed in the opposite end portion 51 of the rod 24. A hole 68c that opens radially outward is formed in a portion of the rod 24 to be inserted into an end portion (left end portion in FIG. 1) of the piston 22. These holes 68a, 68b, and 68c communicate with one another and form a communicating hole 68. The communicating hole 68 allows the space 61 to fluidically communicate with the piston inner space 56 and the space 61 and the piston inner space 56 to fluidically communicate with the secondary port 30. In summary, the secondary pressure chamber 70 communicating with the secondary port 30 is comprised of the region 65 located radially outward relative to the orifice 63, the space 61, the piston inner space 56, the communicating hole 67, and the communicating hole 68.

A communicating hole 71 is formed in the bottom portion 35 of the piston 22 to extend along the axis L1. The communicating hole 71 allows the primary pressure chamber 64 and the back pressure chamber 55 to communicate with each other.

As should be appreciated, in the pressure reducing valve 20, the piston 22 separates an internal space of the housing 21 into the primary pressure chamber 64 and the secondary pressure chamber 70 which are fluidically connected to each other through the orifice 63. The fluid supplied to the primary port 28 flows from the primary pressure chamber 64 to the secondary pressure chamber 70 through the orifice 63. Specifically, the fluid flows downward to the region 65, and flows through the communicating hole 67, the piston inner space 56, and the communicating hole 68 to the secondary port 30, from which the fluid is discharged. Thus, while the fluid is flowing downward within the pressure reducing valve 20, the piston 22 moves axially relative to the rod 24 such that the opening end portion 36 of the piston 22 is axially spaced apart from the opposite end portion 51 of the rod 24.

While the fluid is flowing through the orifice 63, the pressure of the fluid is reduced. In other words, the fluid from the primary pressure chamber 64 is reduced in pressure while flowing within the orifice 63 and the resulting fluid flows to the secondary pressure chamber 70. Therefore, the fluid flowing within the primary port 28, the primary pressure chamber 64, and the back pressure chamber 55 has the primary pressure P1, and the fluid flowing within the secondary port 30 and the secondary pressure chamber 70 has the secondary pressure P2 lower than the primary pressure P1.

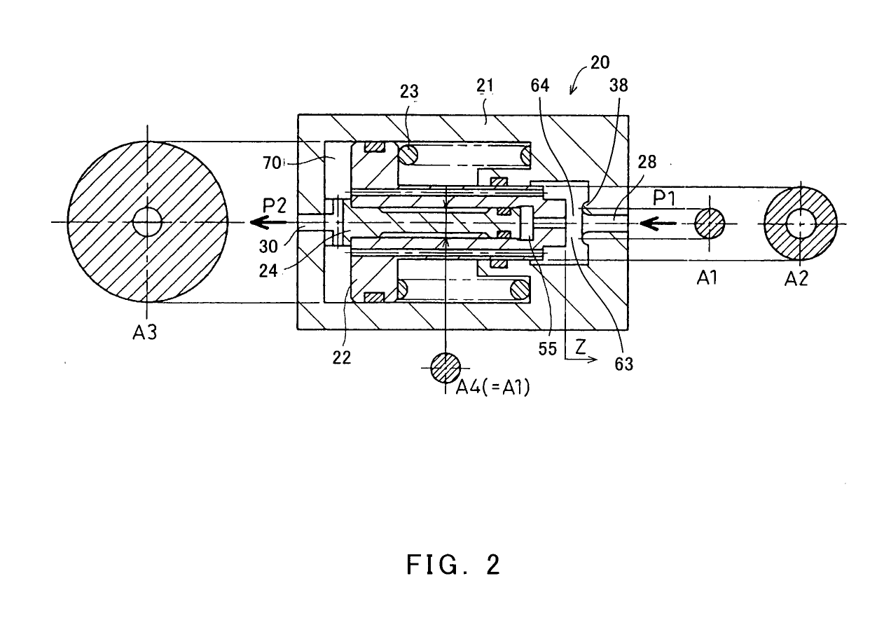

FIG. 2 is a cross-sectional view showing a simplified construction of the pressure reducing valve 20. With reference to FIGS. 1 and 2, the piston 22 has a primary pressure receiving face 75 having a primary pressure receiving area A1 that effectively receives the primary pressure P1 applied in the direction X1 from the fluid within the primary pressure chamber 64. The primary pressure receiving area A1 is obtained by subtracting a pressure receiving area of the piston 22 that receives the primary pressure P1 applied in the opposite direction X2 from the fluid within the primary pressure chamber 64 from a pressure receiving area of the piston 22 that receives the primary pressure P1 applied in the direction X1 from the fluid within the primary pressure chamber 64, i.e., the area of the piston 22 on which the primary pressure P1 from the fluid within the primary pressure chamber 64 effectively acts in the direction X1.

The piston 22 is structured such that parts thereof within the primary pressure chamber 64 face in the opposite direction X2. The piston 22 receives the primary pressure P1 applied only in the direction X1 from the fluid within the primary pressure chamber 64. Therefore, the primary pressure receiving area A1 is represented by the following formula (3) using a diameter D1 of a tip end portion of the protrusion 38 forming the orifice 63 along with the opposed sheet portion 62:

$$A1 = \frac{π}{4} \cdot {D1}^{2} \qquad ( 3 )$$

The back pressure chamber 55 is formed by inserting the opposite end portion 48 of the rod 24 into the piston 22. The piston 22 has a back pressure receiving face 76 having a back pressure receiving area A4 that effectively receives the primary pressure P1 applied in the opposite direction X2 from the fluid within the back pressure chamber 55. The back pressure receiving area A4 is obtained by subtracting a pressure receiving area of the piston 22 that receives the primary pressure P1 applied in the direction X1 from the fluid within the back pressure chamber 55 from a pressure receiving area of the piston 22 that receives the primary pressure P1 applied in the opposite direction X2 from the fluid within the back pressure chamber 55, i.e., the area of the piston 22 on which the primary pressure P1 from the fluid within the back pressure chamber 55 effectively acts in the opposite direction X2. The back pressure receiving area A4 is equal to an area of a cross-section of the one end portion 48 of the rod 24 which is perpendicular to the axis L1. The back pressure receiving area A4 is represented by the following formula (4) using an outer diameter D2 of the one end portion 48 of the rod 24:

$$A4 = \frac{π}{4} \cdot {D2}^{2} \qquad ( 4 )$$

The diameter D1 of the tip end portion of the protrusion 38 is equal to the outer diameter D2 of the one end portion 48 of the rod 24, and therefore, the primary pressure receiving area A1 is equal to the effective back pressure receiving area A4. Thus, the piston 22 has the back pressure receiving face 76 having the effective back pressure area A4 equal to the primary pressure receiving area Al of the primary pressure receiving face 75 that receives the primary pressure P1 applied in the direction X1 from the fluid within the primary pressure chamber 64, and adapted to receive the primary pressure P1 applied in the opposite direction X2 from the fluid within the back pressure chamber 55.

The piston 22 has a secondary pressure receiving face 80 having a pressure receiving area (A3-A2) that effectively receives the secondary pressure P2 applied in the opposite direction X2 from the fluid within the secondary pressure chamber 70.

The pressure receiving area A3 of the piston 22 that receives the secondary pressure P2 applied in the opposite direction X2 from the fluid within the secondary pressure chamber 70 is equal to an area obtained by subtracting the area (=A4) of a cross-section of the opposite end portion 48 of the rod 24 which is perpendicular to the axis L1 from an area of a circle having a diameter corresponding to an outer diameter D3 of the convex portion 41 corresponding to a maximum outer diameter of a portion of the piston 22 that faces in the direction X1 within the space 61. The pressure receiving area A3 is represented by the following formula (5):

$$A3 = \frac{π}{4} \cdot {D3}^{2} - A4 \qquad ( 5 )$$

The pressure receiving area A2 of the piston 22 that receives the secondary pressure P2 applied in the direction X1 from the fluid within the secondary pressure chamber 70 is an area obtained by subtracting the primary pressure receiving area A1 from an area of a circle having a diameter corresponding to a maximum outer diameter D4 of a portion the piston 22 that faces in the opposite direction X2 within the region 65 located radially outward relative to the orifice 63. The pressure receiving area A2 is represented by the following formula (6):

$$A2 = \frac{π}{4} \cdot {D4}^{2} - A1 \qquad ( 6 )$$

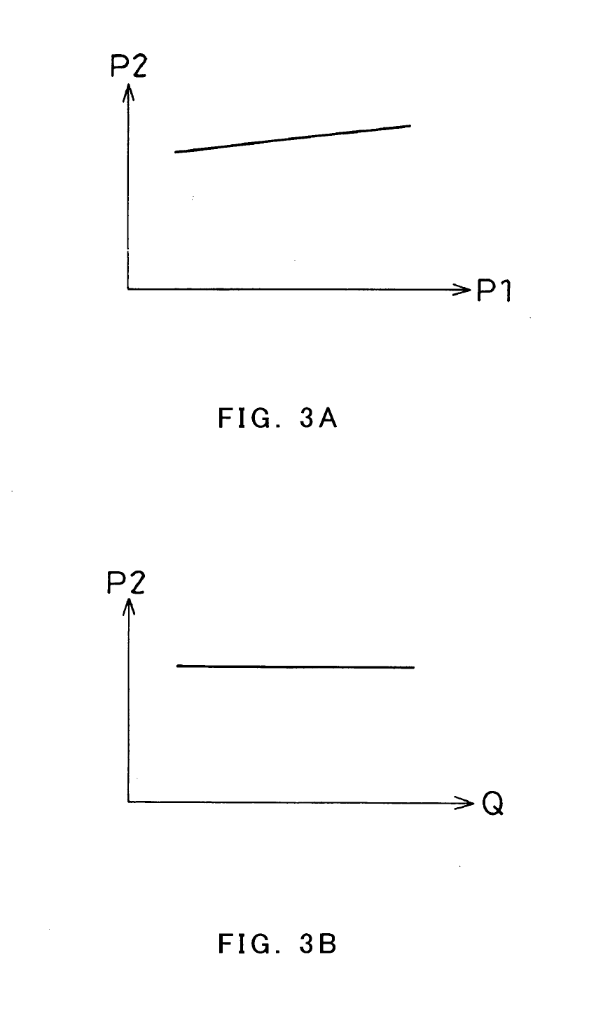

FIGS. 3A and 3B are graphs showing the secondary pressure P2 of the pressure reducing valve 20. FIG. 3A shows the relationship between the primary pressure P1 and the secondary pressure P2, and FIG. 3B shows the relationship between a flow rate Q and the secondary pressure P2. In the pressure reducing valve 20, the secondary pressure P2 is represented by the following formula (7) based on balance of forces applied to the piston 22:

$$P2 = \frac{K \cdot ( Δ H + Z )}{A3 - A2} + \frac{A1 - A4}{A3 - A2} P1 \qquad ( 7 )$$

Z=f(P1,Q) (8)

where K is a spring constant of the spring 23,

ΔH is a flexure of the spring 23 in FIG. 1 from the initial state (free state), and

Z is a displacement of the piston 3 in the opposite direction X from the initial state in FIG. 1. As can be seen from the formula (8), Z is represented by a function of the primary pressure P1 and the flow rate Q of the fluid flowing downward within the pressure reducing valve 20.

As described above, since the back pressure chamber 55 is formed, the piston 22 is adapted to receive the primary pressure P1 at the back pressure receiving area A4 in the opposite direction X2. Thereby, it is possible to balance a force by the primary pressure P1 that the piston 22 receives in the direction X1 and a force by the primary pressure P1 that the piston 22 receive in the opposite direction X2. That is, by setting the primary pressure receiving area A1 equal to the back pressure receiving area A4, a numerator of the second term of the right side in the formula (7) is set to zero (A1−A4=0). By thus setting a value of the second term of the right side in the formula (7) to a constant value (=0), only the first term of the right side varies, regardless of a variation in the primary pressure P1. In contrast to the conventional pressure reducing valve 1 in which the piston 22 does not have the back pressure receiving face 76, the variation ΔP2 in the secondary pressure P2 with respect to the variation ΔP1 in the primary pressure P1 can be significantly reduced as shown in FIG. 3A.

In the pressure reducing valve 20, although the primary pressure receiving area A1 increases by increasing the diameter D1 of the tip end portion of the protrusion 38 for increasing a flow capacity, i.e., a maximum allowable flow, the increase in the variation ΔP2 in the secondary pressure P2 with respect to the variation ΔP1 in the primary pressure P1 can be inhibited by increasing the back pressure receiving area A4. Therefore, unlike in the conventional pressure reducing valve 1 in which the piston 22 does not have the back pressure receiving area 76, it is not necessary to increase the pressure receiving area A3 of the piston 22 that receives the secondary pressure P2 applied in the opposite direction X2 and increase the outer diameter D3 of the convex portion 41 corresponding to the maximum outer diameter of the piston 22, for increasing the maximum allowable flow. In this construction, an increase in the radial dimension of the pressure reducing valve 20 can be inhibited. As should be appreciated, regardless of the flow rate Q, the variation ΔP2 in the secondary pressure P2 with respect to the variation ΔP1 in the primary pressure P1 can be reduced while inhibiting an increase in the radical dimension of the pressure reducing valve 20.

By partially inserting the rod 24 into the piston 22, the back pressure chamber 55 can be formed and the above-described effect can be obtained in a simple manner. Further, by using the piston inner space 56 between the piston 22 and the rod 24 as a passage through which the fluid flows, it is not necessary to form an axial passage in the piston 22 to allow the region 64 of the space 60 to communicate with the space 61. The pressure reducing valve 20 can be manufactured simply and easily without a complex process. In addition, since reduction of strength of the piston 22 caused by formation of such a passage does not occur, the thickness in the radial direction of the piston 22 can be reduced. Correspondingly, the radial dimension of the pressure reducing valve 20 can be reduced. As a matter of course, the present invention is to be understood as including a construction in which the axial passage is formed in the piston 22 to allow the region 64 of the space 60 to communicate with the space 61.

Since the cap member 27 provided with the protrusion 38 is axially adjustable relative to the housing body 25, an axial spacing between the protrusion 38 and the seat portion 62 of the piston 22 is adjustable and a pressure reduction ratio of the secondary pressure P2 with respect to the primary pressure P1 is adjustable.

The pressure reducing valve 20 may be provided on a high-pressure tank such as a tank containing oxygen, which is, for example, carried by a fireman in scene of the fire, and used to discharge the oxygen within the high pressure tank while reducing its pressure. Since the high-pressure tank is required to reduce the radial dimension for the purpose of strength, the pressure reducing valve 20 capable of reducing the radial dimension thereof is suitable in such uses.

Alternatively, the housing 21 and the rod 24 may be integral with each other. The pressure reducing valve 20 may be provided on high-pressure tanks other than the tank carried by the fireman, for example, a tank storing gases of a fuel cell equipped in an electric car. In a further alternative, the pressure reducing valve 20 may be provided on fluid pressure devices other than the tank. The fluid may be gases or liquid.

Numerous modifications and alternative embodiments of the invention will be apparent to those skilled in the art in the light of the foregoing description. Accordingly, the description is to be construed as illustrative only, and is provided for the purpose of teaching those skilled in the art the best mode of carrying out the invention. The details of the structure and/or function may be varied substantially without departing from the spirit of the invention.

What is claimed is:

1. A pressure reducing valve comprising:
a housing provided with a primary port and a secondary port;
a piston held within the housing to be movable in an axial direction of the valve and configured to separate an internal space of the housing into a primary pressure chamber connected to the primary port and a secondary pressure chamber connected to the secondary port, the piston including a primary pressure receiving face having a primary pressure receiving area that receives a primary pressure applied in one direction in the axial direction from a fluid within the primary pressure chamber, a back pressure receiving face having a back pressure receiving area equal to the primary pressure receiving area, the back pressure receiving face being adapted to receive the primary pressure applied in an opposite direction in the axial direction from the fluid within a back pressure chamber fluidically connected to the primary pressure chamber and kept at the primary pressure, and a secondary pressure receiving face that receives a secondary pressure applied in the opposite direction from a fluid within the secondary pressure chamber; and
a spring means configured to apply a force to the piston in the one direction.

2. The pressure reducing valve according to claim 1, further comprising:
a rod provided within the housing, the rod being inserted into the piston to be movable relative to the piston in the axial direction to allow the back pressure chamber to be formed between the rod and the piston.
